(19) United States
(12) Patent Application Publication
(10) Pub. No.: US 2024/0160861 A1
(43) Pub. Date: May 16, 2024

(54) TRANSFORMER TRANSLATION SYSTEM FOR DEEP LEARNING USING TRIPLE SENTENCE PAIR

(71) Applicant: Insight Vessel Co., Ltd., Seoul (KR)

(72) Inventor: Ji Won NAM, Seoul (KR)

(73) Assignee: Insight Vessel Co., Ltd., Seoul (KR)

(21) Appl. No.: 18/550,718

(22) PCT Filed: Feb. 16, 2022
(86) PCT No.: PCT/KR2022/002275

§ 371 Date: Sep. 15, 2023

(30) Foreign Application Priority Data
Mar. 17, 2021 (KR) 10-2021-0034738

(51) Int. Cl. G06F 40/51

(52) U.S. Cl. CPC G06F 40/51

(57) ABSTRACT

A transformer translation system for deep learning using triple sentence pair is designed to do both a rough translation and a revision of rough translations, and utilize reinforcement learning using a deep learning facility to produce data of refined translations. And this transformer translation system can translate literary works, webtoons, subtitles, and the like, which can be commercially distributed or exported to overseas markets, taking into account feelings, nuances, atmosphere, jargons, tones of voice, writers' intentions, context, etc. so that consumers or readers can enjoy not mere plain translations but refined, high-quality translations. Furthermore, this transformer translation system for deep learning using triple sentence pair may automatically produce the final translations, which can be commercially viable, continuously for an indefinite time without limit.

### CROSS REFERENCE TO THE RELATED APPLICATIONS

This application is the national phase entry of International Application No. PCT/KR2022/002275, filed on Feb. 16, 2022, which is based upon and claims priority to Korean Patent Application No. 10-2021-0034738, filed on Mar. 17, 2021, the entire contents of which are incorporated herein by reference.

### TECHNICAL FIELD

This invention concerns a translation system. More specifically, it is a transformer translation system for deep learning using triple sentence pair, which is designed to do both a rough translation and a revision of rough translations, and utilize reinforcement learning using a deep learning facility to produce data of refined translations. And this transformer translation system can translate literary works, webtoons, subtitles, and the like, which can be commercially distributed or exported to overseas countries, taking into account feelings, nuances, atmosphere, jargons, tones of voice, writers' intentions, context, etc. so that consumers or readers can enjoy not mere plain translations but refined, high-quality translations.

### BACKGROUND

Translation is one of the most important skills in exporting or distributing countless contents of Korea (e.g., those of web novels, webtoons, and subtitles) to overseas countries, and in becoming a successful player in value-added services of knowledge.

However, translations suitable for commercial use and distribution can cost a good deal of money because you need to use skilled professional translators, and can also take a long time, all of which makes such an endeavor ineffective.

Contents of such types of writing are usually huge, and the costs of translation increase in direct proportion to the volume of translation (ten novels can contain 1.5 million words on average).

Machine translation can be very fast and thus can do a huge amount of translation. However, it is still impossible for the machine translation to produce natural translations in the commercial contents or literary works. It can only do a simple translation of them.

Even if machine learning is possible in the field of translation, it is practically impossible for the machine translation to meaningfully consider jargons, context, emotional changes of characters in a novel, or nuances in doing a translation. Furthermore, a highly advanced system of machine translation can cost an astronomical amount of money to carry out machine learning (e.g., GPT-3, currently the most advanced model that processes natural languages, can cost five billion won for language learning only). Apart from the massive costs, machine translation has one major shortcoming: It cannot advance if it is not supplied with proper learning data continuously.

Since the industry of contents is very vulnerable to theft and has great weaknesses in distribution, copyright owners including publishers naturally have many risks to consider before they can provide their original contents and decide to expand their business into overseas markets.

Translation is still an obstacle to exporting quality Korean contents to overseas markets.

### LITERATURE ON THE PRIOR ART

### Patent Literature

(Patent Literature 0001) Korean Patent Registration No.: No. 10-1099196

### SUMMARY

### Problems to be Solved

In order to solve the above-mentioned problems, I present a transformer translation system for deep learning using triple sentence pair for a solution to them, which is designed to do both a rough translation and a revision of rough translations, and utilize reinforcement learning using a deep learning facility to produce data of refined translations. And this transformer translation system can translate literary works, webtoons, subtitles, and the like, which can be commercially distributed or exported to overseas countries, taking into account feelings, nuances, atmosphere, jargons, tones of voice, writers' intentions, context, etc. so that consumers or readers can enjoy not mere plain translations but refined, high-quality translations.

### Means to Solve the Problems

The transformer translation system for deep learning using triple sentence pair, which was invented to fulfill the above purposes and functions, is composed of the following:
A database of original contents, which receives original files of contents via a publishers' terminal;
A translator for a rough translation that produces data of rough translations by doing a machine translation of the above original files of contents using a deep-learning algorithm of an artificial neural network;
A workstation for revision that imports the above original contents and the above data of rough translations, displays both of them side by side on the first monitor, and saves the revised translations which it revises by comparing the above original contents with the above rough translations;
A terminal for revision and proofreading that imports the above original contents and the above data of revised translations, displays them side by side on the second monitor, and saves the data of translations which it revises and proofreads by comparing the above original contents with the above revised translations;
A database of the final translations that saves the data of translations revised and proofread which are received from the terminal for revision and proofreading;
An interface of the administrator's page that provides a user interface, through which the above data of final translations revised and proofread can be accessed or downloaded by connecting to the above database of the final translations;
A database of revised sentence pairs, which is directly connected to the terminal for revision and proofreading, that generates triple sentence pairs made up of sentences in the source language, roughly translated sentences, and sentences in the revised translations that are the data of the above revision and proofreading, all of which will be used for reinforcement learning, and then receives and saves those triple sentence pairs from the terminal for revision and proofreading; and
A translation unit of reinforcement learning that receives the above triple sentence pairs from the database of revised sentence pairs and then automatically revises them using a translation algorithm of reinforcement learning before the above workstation for revision does.

### Effects of the Invention

By the composition and mechanisms stated above, this invention can automatically produce triple sentence pairs and thus secure permanent sources of data with significantly lower costs. In addition, it can also create data of translations revised and proofread which takes into account nuances, context, feelings, jargons, and other such things.

This invention can easily go beyond the mere conveyance of meaning and raise the quality of translations to a substantially high level where readers can use them for practical purposes without any problems.

This invention can perform an automatic revision and proofreading based on reinforcement learning of triple sentence pairs, during which a process of double revision and/or proofreading (between sentences in the original text and sentences in the revised translations; between sentences in the rough translations and sentences in the revised translations) is carried out for more accuracy and perfection.

This invention can not just create profits from the workstation for revision but also generate sources of data so that machine translation can improve on a stable basis without having to rely on external learning data or worrying about depletion of such data.

Since publishers can directly upload their original contents targeted for overseas markets, all the processes of translation are done on a black box model, and all their interactions with the outside parties are traceable with logs when using this invention, the risk of leaks or loss of their contents can be greatly reduced.

This invention may automatically produce the final translations, which can be commercially viable, continuously for an indefinite time without limit. And by the process of achieving singularity (meaning: the final evolution of AI, or the completion of AI), a demand for essential human revision and proofreading of translations can be significantly reduced or completely unnecessary, in which case profitability can be enormously increased.

### BRIEF DESCRIPTION OF THE DRAWINGS

FIG. 1 shows the configuration of this invention, a transformer translation system for deep learning using triple sentence pair, which is drawn according to an embodiment of this invention.

FIG. 2 demonstrates how the transformer translation system for deep learning using triple sentence pair does a translation according to the first embodiment of the invention.

FIG. 3 displays an example of the screen of the workstation for revision, shown according to an embodiment of the invention.

FIG. 4 shows an example of an interface of the administrator's page, according to an embodiment of the invention.

FIG. 5 demonstrates how this transformer translation system does a translation according to the second embodiment of the invention.

FIG. 6 shows how a translation algorithm of reinforcement learning in a translation unit of reinforcement learning functions, according to the second embodiment of the invention. And

FIG. 7 describes how this transformer translation system does a translation according to an embodiment of the invention.

### DETAILED DESCRIPTION OF THE EMBODIMENTS

In the context of this entire patent specification, if a certain thing is said to “include” a certain constituent part, it means the thing can include more than that, not excluding all the others, unless specified otherwise.

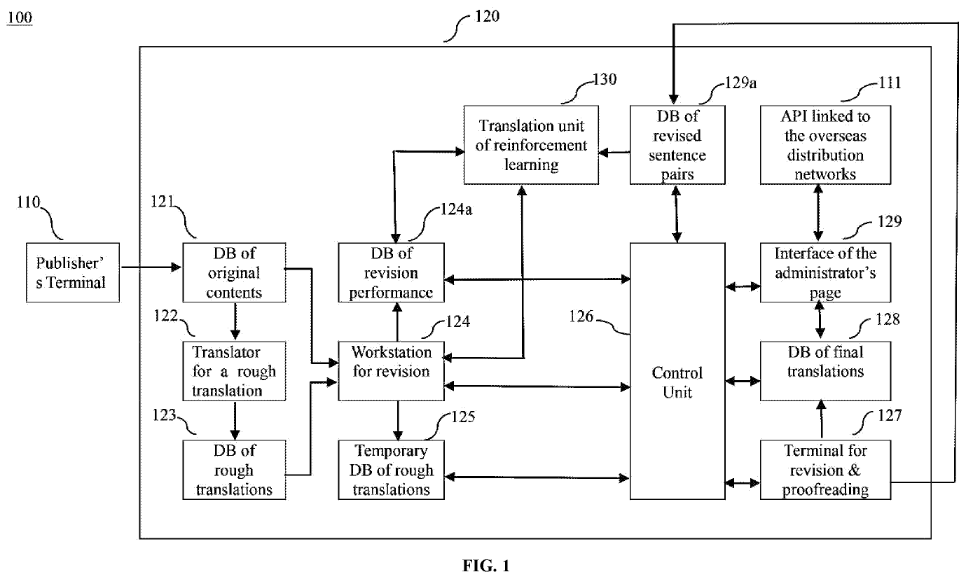

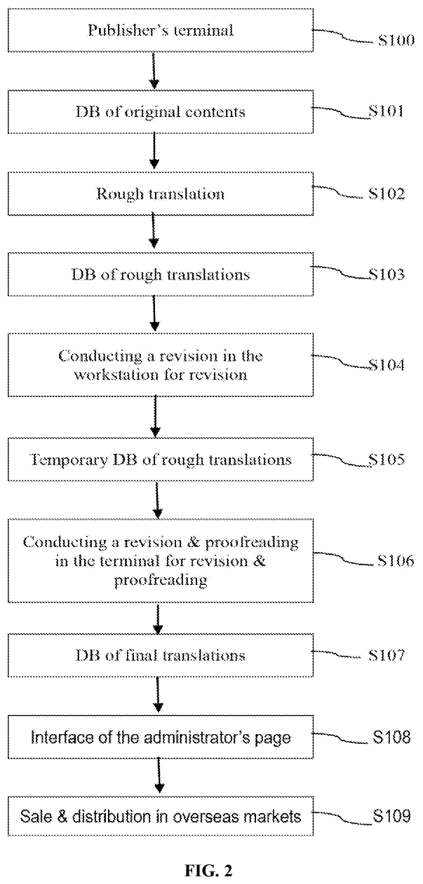

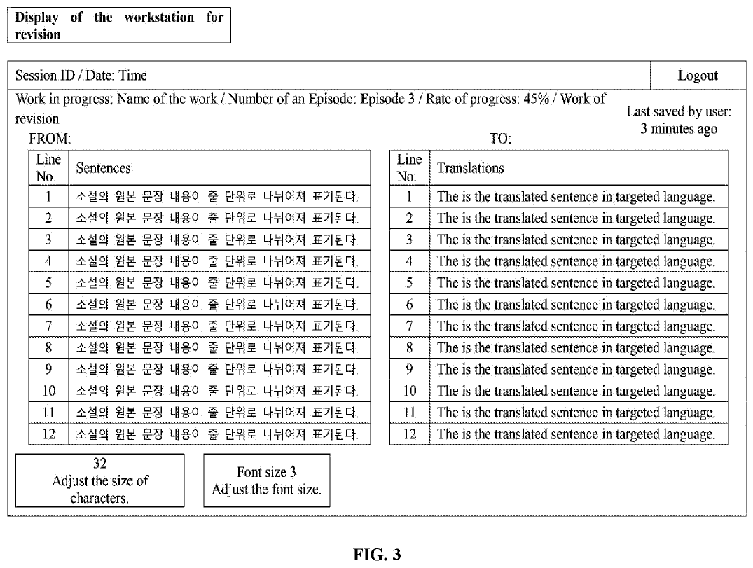

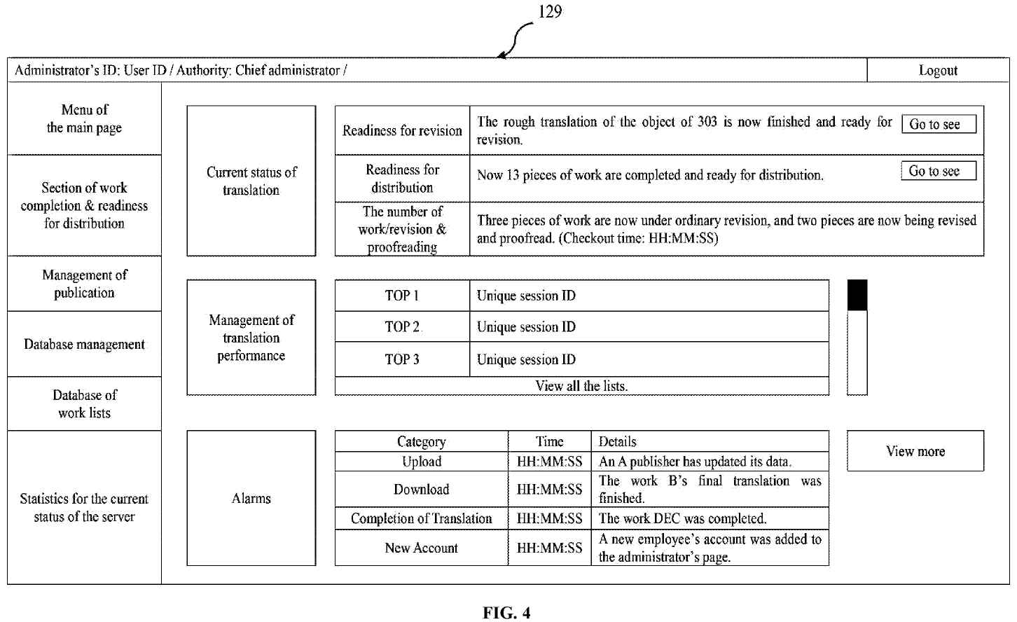

FIG. 1 shows the configuration of this invention, a transformer translation system for deep learning using triple sentence pair, drawn according to an embodiments of this invention. FIG. 2 demonstrates how this transformer translation system does a translation according to the first embodiment of the invention. FIG. 3 displays an example of the screen of the workstation for revision, shown according to an embodiment of the invention. FIG. 4 shows an example of an interface of the administrator's page, shown according to an embodiment of the invention.

A transformer translation system for deep learning using triple sentence pair (100) designed according to the embodiments of this invention includes a publisher's terminal (110) and a translation-providing server (120).

The translation-providing server (120) includes a database of original contents (121); a translator for a rough translation (122); a database of rough translations (123); a workstation for revision (124); a database of revision performance (124a); a temporary database of rough translations (125); a control unit (126); a terminal for revision and proofreading (127); a database of the final translations (128); an interface of the administrator's page (129); a database of revised sentence pairs (129a); and a translation unit of reinforcement learning (130).

A publisher or a copyright owner, who has entered into an export contract or a distribution contract with a businessman, can log into their approved accounts on a platform that provides a translation service that uses deep learning via a publisher's terminal (110), which is a web-based system, and uploads their documents to be translated after having their user IDs authenticated. Here in this context, the above businessman means a direct user of this system, who makes profits from selling the final translations revised and proofread (those written in a foreign language) to overseas distributors and shares some of their profits with the publisher and/or the copyright owner.

A publisher or a copyright owner is the copyright owner of Korean contents (web novels, webtoons, or subtitles) and is an interested party who will make an export contract with a businessman and supply their original text or contents to them.

A publisher's terminal (110) is a display that shows up when a publisher or a copyright owner logs into it with a publisher's user account. And then they can upload their original files of contents to the publisher's terminal (110).

A publisher's terminal (110) provides the original files of contents to a translation-providing server (120) (S100).

A database of original contents (121) stores the original files of contents that a publisher or a copyright owner uploads via a publisher's terminal (110) (S101). The original files of contents stored in the database of original contents (121) may be encrypted in a form no human can recognize.

A translator for a rough translation (122) does an automatic rough translation (machine translation) continuously for any amount of time depending on the quota of a server after automatically extracting the original files of contents from the database of original contents (121) (S102).

At this time, the priority of work can be decided in order of dates where the original files of contents have been saved, or in order of sales tagged when saving data, or in order of importance or the size of data.

A translator for a rough translation (122) does a machine translation, which is now a widely used method of translation, and uses Google APIs or Naver APIs or the AI of an artificial neural network (a form of supervised learning) in doing a translation. In this case, a transformer neural network algorithm is used as a deep learning algorithm.

When doing a rough translation, a translator for a rough translation (122) indexes the sets of original sentences and their corresponding translations sentence by sentence so that they can be easily traced as a set later.

A database of rough translations (123) extracts and saves the rough translations automatically done by the translator for a rough translation (122) and accumulates the data of rough translations on a steady basis (S103).

A workstation for revision (124), an AI-based revision system, displays the rough translations drawn from the database of rough translations (123) and their original text extracted from the database of original contents (121) side by side on the first monitor (a display of the workstation; refer to FIG. 3). In short, it arranges sentences in a source language (e.g., Korean) alongside sentences in a target language (e.g., English).

A workstation for revision (124) revises the rough translations by comparing the sentences in the source language (e.g., Korean) with those in the language used in a rough translation (e.g., English).

Data of revised translations done by the workstation for revision (124) will be transmitted to a temporary database of rough translations (125) (S104).

At this time, details about the revisions carried out by the workstation for revision (124) are transmitted to a database of revision performance (124a) at the same time and saved there. And the saved data are also shared with an interface of the administrator's page (129).

The temporary database of rough translations (125) receives the data of revised translations from the workstation for revision (124) and saves them (S105).

A terminal for revision and proofreading (127) displays the data of revised translations imported from the temporary database of rough translations (125) and the original contents drawn from the database of original contents (121) on a display unit (not shown) side by side.

A terminal for revision and proofreading (127), an AI-based system for revision and proofreading, automatically carries out a revision and proofreading by reading the revised translations (e.g., English translations) and simultaneously comparing them with their original text (e.g., the original Korean text).

A terminal for revision and proofreading (127) transmits its final work of revision and proofreading, or the data of revision and proofreading (e.g., sentence pairs), which are produced by comparing the revised translations with their original text sentence by sentence, to a database of the final translations (128) (S106).

At this time, the data of revision and proofreading, which are the final translations revised and proofread by the terminal for revision and proofreading (127), are transmitted to a database of revised sentence pairs (129a) at the same time and saved there. And the saved data (sentence pairs) will be shared in the work of translation of reinforcement learning and used in reinforcement learning.

A database of the final translations (128) receives the data of revision and proofreading (sentence pairs translated in a level that is commercially viable (e.g., sentence pairs composed of Korean and English sentences)), which are the results of an automatic revision of the rough translations using reinforcement learning and an automatic revision and proofreading of them, from the terminal for revision and proofreading (127) and saves them (S107).

At this time, the sentence pairs (e.g., sentence pairs composed of Korean and English sentences) saved in the database of the final translations (128) will be highlighted both in the workstation for revision (124) and the terminal for revision and proofreading (127).

The data of revision and proofreading, the final work of translations, are quality translations that are commercially viable. And the data are saved as sentence pairs in a database of revised sentence pairs (129a). Later, they can be reused for translation of reinforcement learning and deep learning, both of which are introduced to improve the accuracy and efficiency of translation.

As shown in the FIG. 4, an interface of the administrator's page (129) provides an user interface with which users can view the data of final translations or download them as it is linked to the database of the final translations (128) (S108).

The final documents or translations, which are the final work of translations revised and proofread by this system, can be uploaded to an overseas distribution network via an interface of the administrator's page (129) for distribution or sale overseas. Here, the overseas distribution network means a distribution network linked to platforms, online stores, and the like which are already selling various types of electronic books, web novels, webtoons, etc. written in a foreign language (e.g., English). And selling the final work of translations completed in a translation-providing server (120) is done by this distribution network.

An interface of the administrator's page (129) can be set to automatically upload text via an API (111) linked to overseas distribution networks (S109).

In addition, because the interface of the administrator's page (129) is systematically interconnected to the databases in a translation-providing server (120), users can manage all things about translation by using this. And it can also help users solve problems such as those of providing complicated documents and data, and avoid a mix-up of procedures, inefficient communication, a security breach, and exposure of copyrighted sources.

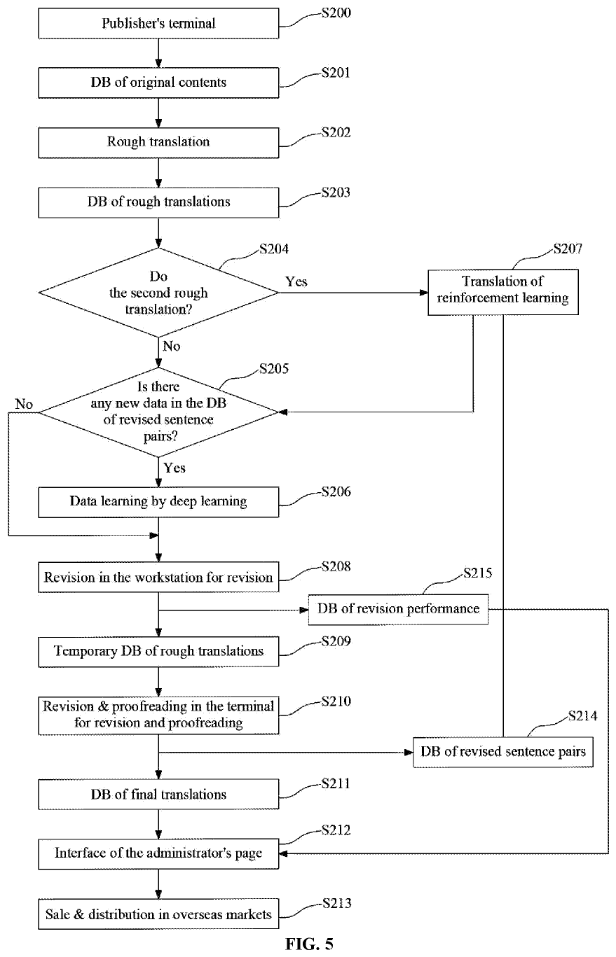

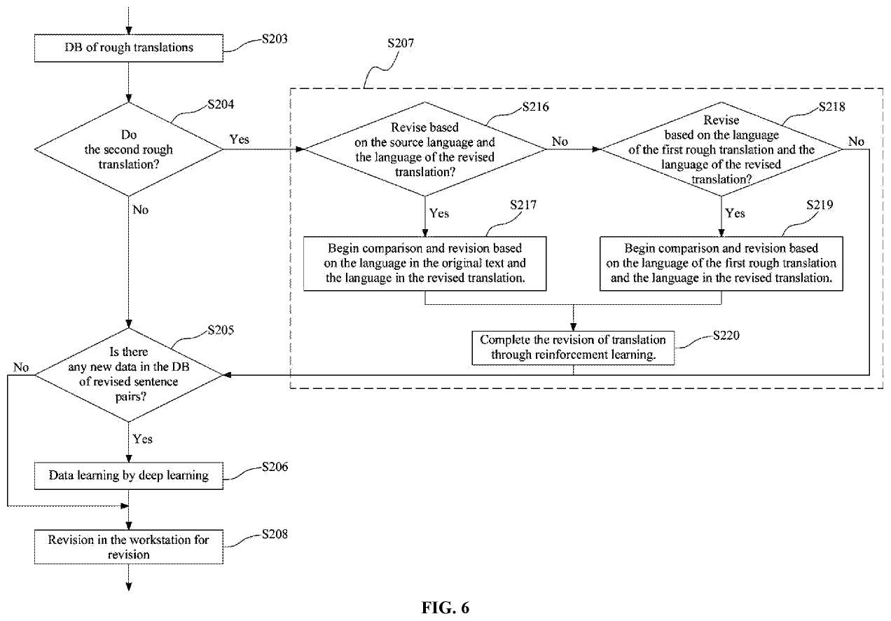

FIG. 5 shows how a transformer translation system for deep learning using triple sentence pair does a translation according to the second embodiment of the invention. And FIG. 6 shows how a translation algorithm of reinforcement learning in a translation unit of reinforcement learning functions according to the second embodiment of the invention.

The second embodiment of the invention is described in detail around the differences from the first embodiment without mentioning the overlapping stages.

A publisher's terminal (110) provides original files of contents to a translation-providing server (120) (S200).

A database of original contents (121) saves original files of contents, which a publisher or a copyright owner uploads via a publisher's terminal (110) (S201).

A translator for a rough translation (122) does an automatic rough translation (machine translation) continuously for any amount of time depending on the quota of a server by automatically importing the original files of contents from the database of original contents (121) (S202).

A database of rough translations (123) imports and saves the rough translations automatically done by the translator for a rough translation (122) and accumulates the data of rough translations on a continual basis (S203).

Like this, as a database of rough translations (123) steadily accumulates the data of rough translations, and as a database of revised sentence pairs (129a) also amasses sentence pairs (new data) revised and proofread once and for all, an infrastructure can be built, which can maximize the learning effects of revision, and thus the accuracy and efficiency of translation will continually improve.

Moreover, since the system of this invention has built-in properties of deep learning and reinforcement learning in doing a translation, the level of a second rough translation can be high (new quality data will continually be accumulated as the frequency of translation increases and the learning effects of translation improves. With this mechanism, more accurate, efficient translation can be possible).

Therefore, the system of this invention can drastically reduce the necessity of human revision and proofreading in producing a complete translation. So naturally the speed of completing translations will steadily improve and thus save the costs of translation as much as possible.

Before a workstation for revision (124) performs a revision using the data from a database of rough translations (123) and the data of original contents, a signal that requests a second rough translation can be transmitted to a control unit (126).

In this case, the control unit (126) checks if the signal requesting a second rough translation is received (S204).

A second rough translation can begin after a database of revised sentence pairs (129a), which contains the prior data of final translations already completed by a terminal for revision and proofreading (127), sends a signal to a control unit.

The database of revised sentence pairs (129a) checks if it has one million revised translations in it. If it does, it sends a request for a second rough translation to a control unit. But if it contains less than one million revised translations, it does not send a signal that requests a second rough translation.

A control unit (126) confirms whether a signal requesting a second rough translation is received from the database of revised sentence pairs (129a) and then asks the database of revision performance (124a) to select a translation algorithm with which a second translation will be done.

The database of revision performance (124a) sends a translation algorithm to a control unit (126) when the control unit requests a second translation after it has received a signal requesting the second translation from the database of revised sentence pairs (129a). And before the database of revision performance (124a) does so, it selects which translation algorithm it will send, first based on the genre of the text (e.g., contemporary novels, fantasy literature, autobiography, daily episodes, action stories, war novels, etc.) and second the compatibility with an algorithm (e.g., 1. a transformer algorithm; 2. a convolutional neural network (CNN) algorithm; 3. a GPT-type algorithm; and 4. an ALBLEU-style morphological analysis algorithm, etc.). In addition, computing efficiency and the suitability of a genre (an algorithm that is closest to 100% in the trustability of translation) are also considered in selecting an algorithm.

At this time, in determining the computing efficiency and the suitability of a genre, the database of revision performance takes into account genre-specific words, characteristics of the context, a particular atmosphere, feelings, nuances, and the like.

The control unit (126) transmits a signal requesting a translation of reinforcement learning to a translation unit of reinforcement learning (130) when it confirms the conditions of the request for a second rough translation and that an appropriate translation algorithm is selected.

The translation unit of reinforcement learning (130) carries out a revision of translations through reinforcement learning using a translation algorithm of reinforcement learning selected by the database of revision performance (124a) (S207).

The above stage of S207 will be later described in detail, where the translation unit of reinforcement learning executes a translation algorithm of reinforcement learning according to the second embodiment of this invention.

A translation algorithm of reinforcement learning is a technology where it arranges a sentence input and a sentence output in a pair and finds the most suitable expressions and the results of translation using the method of deep learning. The technology of deep learning utilizes a transformer algorithm, a convolutional neural network (CNN) algorithm, a GPT-type algorithm, and an ALBLEU-style morphological analysis algorithm, and the like for machine learning.

The control unit (126) checks whether a new data exists via the database of revised sentence pairs (129a) if it cannot receive a signal that requests a second rough translation (S205).

The control unit (126) performs data learning in the translation unit of reinforcement learning (130) using a deep learning facility in a translation algorithm of reinforcement learning, if a new data exists in the database of revised sentence pairs (129a) (S206).

If a signal requesting a second rough translation is not received and a new data doesn't exist in the database of revised sentence pairs, a database of rough translations is directly transmitted to the workstation for revision so that the work of revision can be carried out.

The workstation for revision (124) conducts a revision by comparing original contents (e.g., the original text in Korean) with their rough translations (e.g., the translated text in English) (please refer to the display of FIG. 3).

The data of translations revised in the workstation for revision (124) will be transmitted to a temporary database of rough translations (125) (S208).

At this time, details of the revision done by the workstation for revision (124) are transmitted to a database of revision performance (124a) at the same time and saved there. And the saved data are also shared with an interface of the administrator's page (129).

The temporary database of rough translations (125) receives the data of revised translations from the workstation for revision (124) that has conducted the revision and then saves them (S209).

A terminal for revision and proofreading (127) displays the data of revised translations imported from the temporary database of rough translations (125) and the original contents extracted from the database of original contents (121) on a display unit (not shown) side by side.

A terminal for revision and proofreading (127), an AI-based system for revision and proofreading, automatically carries out the work of revision and proofreading by reading the data of revised translations (e.g., English translations) and simultaneously comparing them with their original contents (e.g., the original text in Korean).

A terminal for revision and proofreading (127) transmits its final work of revision and proofreading, or the data of revision and proofreading (e.g., sentence pairs), which are produced by comparing the revised translations with their original text sentence by sentence, to a database of the final translations (128) (S210).

At this time, the data of revision and proofreading, which are the final translations revised and proofread in the terminal for revision and proofreading (127), are transmitted to a database of revised sentence pairs (129a) at the same time and saved there. And the saved data (sentence pairs) will be shared in the work of translation of reinforcement learning and used in reinforcement learning.

A database of the final translations (128) receives the data of revision and proofreading (sentence pairs translated in a level that is commercially viable (e.g., sentence pairs composed of Korean and English sentences)), which are the results of an automatic revision of the rough translations using reinforcement learning and an automatic revision and proofreading of them, from the terminal for revision and proofreading (127) and saves them (S211).

At this time, the sentence pairs (e.g., sentence pairs composed of Korean and English sentences) saved in the database of the final translations (128) will be highlighted both in the workstation for revision (124) and the terminal for revision and proofreading (127).

The data of revision and proofreading, which are the final work of translations, are quality translations that are commercially viable. And the data are saved as sentence pairs in a database of revised sentence pairs (129a). Later, they can be reused for translation of reinforcement learning and deep learning, both of which are introduced to improve the accuracy and efficiency of translation.

An interface of the administrator's page (129) provides an user interface with which users can look up the data of final translations or download them as it is linked to the database of the final translations (128) (S212).

The final documents or translations, which are the final work of translations revised and proofread by this system, can be uploaded to an overseas distribution network via an interface of the administrator's page (129) for distribution or sale overseas. Here, the overseas distribution network means a distribution network linked to platforms, online stores, and the like which are already selling various types of electronic books, web novels, webtoons, etc. written in a foreign language (e.g., English). And selling the final work of translations completed in a translation-providing server (120) is done by this distribution network.

An interface of the administrator's page (129) can automatically upload documents via an API (111) linked to overseas distribution networks and sell them to overseas distributors (S213).

Furthermore, because the interface of the administrator's page (129) is systematically interconnected to the databases in a translation-providing server (120), users can manage all things about translation by using this. And it can also help users solve problems such as those of providing complicated documents and data, and avoid a mix-up of procedures, inefficient communication, a security breach, and exposure of copyrighted sources.

A terminal for revision and proofreading (127) generates triple sentence pairs from the data of translations it has revised and proofread.

The triple sentence pairs are composed of original sentences in the source language, sentences of a rough translation, and sentences of a revised translation (a data for revision and proofreading), and are used as data for reinforcement learning.

A database of revised sentence pairs (129a) receives triple sentence pairs from the terminal for revision and proofreading (127) and saves them (S214).

The database of revised sentence pairs (129a) transmits its triple sentence pairs to the translation unit of reinforcement learning (130).

The triple sentence pairs saved in the database of revised sentence pairs (129a) will be put in a translation algorithm of reinforcement learning and be utilized as a means of steadily enhancing the capability of revision.

At this time, the translation algorithm of reinforcement learning learns using a transformer algorithm, a convolutional neural network (CNN) algorithm, a GPT-type algorithm, an ALBLEU-style morphological analysis algorithm, and the like.

The translation unit of reinforcement learning (130) automatically conducts a revision using the translation algorithm of reinforcement learning, before the workstation for revision (124) carries out a revision (that is, before it uploads data to the temporary database of rough translations (125)) (S207).

The workstation for revision (124) generates information on the performance of revision, which is a breakdown of revision, and sends it to the database of revision performance (124a) (S215).

Information on the performance of revision shows how many words are revised in a given time frame (e.g., a day, a month, or a year), how the rate of correction is, and how efficiently a revision is carried out at a time.

The results saved in the database of revision performance (124a) will be provided through the interface of the administrator's page (129) as basic data for building a more accurate, more efficient translation system.

A detailed description of the stage of S207, which is about how a revision of translations is done via reinforcement learning, is as follows.

When the control unit (126) receives a signal responding to a request for a second rough translation from the database of revised sentence pairs, it sends the signal of a second rough translation to the translation unit of reinforcement learning (130) (S204).

When the translation unit of reinforcement learning (130) receives the signal requesting a second rough translation from the control unit (126), it will determine whether to conduct a revision based on a language in an original file of contents (e.g., Korean) and a language in the data of revision and proofreading (e.g., English) (S216).

If the translation unit of reinforcement learning (130) determines to carry out a revision based on the language in the original file of contents and the language in the data of revision and proofreading, it makes sure languages are matched by comparing the language in the original file and the language in the revised translations (S217) and then performs a revision of the translations using deep learning in the translation algorithm of reinforcement learning (S220).

If the translation unit of reinforcement learning (130) decides not to perform a revision based on the source language in the original file of contents and the target language in the data of revision and proofreading, it will determine whether to conduct a revision based on the language used in the first rough translation in the stage S202 and the language used in the revised translations (S218).

If the translation unit of reinforcement learning (130) carries out a revision based on the language used in the first rough translation and the language used in the revision, it makes sure languages are matched by comparing the language used in the first rough translation and the language used in the revision and then conducts a revision of the translations using deep learning in the translation algorithm of reinforcement learning (S220).

This invention is designed to do both a rough translation and a revision of rough translations, and utilize reinforcement learning using a deep learning facility. And this transformer translation system can translate literary works, webtoons, subtitles, and the like, which can be commercially distributed or exported to overseas countries, taking into account feelings, nuances, atmosphere, jargons, tones of voice, writers' intentions, context, etc. so that consumers or readers can enjoy not mere plain translations but refined, high-quality translations.

This invention may maximize the completeness of translation because its steady, continuous learning will greatly raise the level of machine translation (the first and second rough translations). And by the process of achieving singularity (meaning: the final evolution of AI, or the completion of AI), a demand for human revision and proofreading of translations can be significantly reduced or completely unnecessary, in which case profitability can be hugely increased (more than 200%).

Moreover, this invention's system may automatically produce the final translations, which can be commercially viable, continuously for an indefinite time without limit. Therefore, profitability will significantly increase.

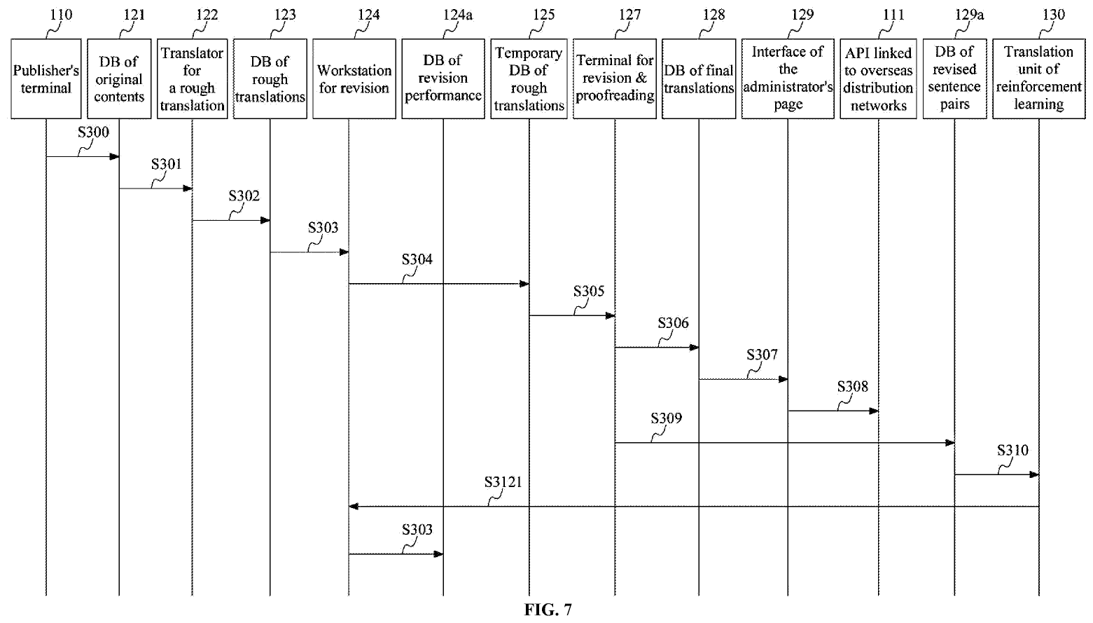

FIG. 7 shows how this transformer translation system for deep learning using triple sentence pair does a translation according to an embodiment of this invention.

A publisher or a copyright owner will upload their files of contents to a publisher's terminal (110).

If a publisher or a copyright owner wants to upload web novels, they need to upload them to a publisher's terminal (110) in a text file. In the case of webtoons, they need to upload them to the publisher's terminal (110) in one of the following formats: PNG, JPEG, or Bitmap. And as for subtitles, they need to upload them to the publisher's terminal (110) in a data format (a point of play in a subtitle, the length of play in a subtitle, text in a subtitle) such as JSON.

A publisher's terminal (110) transmits the original files of contents, which a publisher or a copyright owner uploads, to a database of original contents (121) (S300).

A publisher's terminal (110) generates original files of contents embedded with parameters before sending them to a database of original contents (121).

If an original file of contents is a text file, the publisher's terminal (110) will generate a function of saveTXT before transmitting it to the database of original contents (121).

In this case, a function of saveTXT includes the following parameters: a txtfile [1, linenum] (a text file (numbers from the first line to the last line)); linesize (the total number of lines); size (file size); timestamp (transmission time); publisher (a publishing company); BookName (name of the work); EpisodeNum (the number of an episode); lang (the kind of language); and processed (the completion of a rough translation: initially 0, and 1 if completed).

If an original file of contents is a webtoon, the publisher's terminal (110) will generate a function of saveToon before sending it to the database of original contents (121).

In this case, a function of saveToon includes the following parameters: BookName (name of the work); EpisodeNum (number of an episode); publisher (a publishing company); timestamp (transmission time); size (file size); lineNum (a line at which object); lang (the kind of language); processed (the completion of a rough translation: initially 0, and 1 if completed); and script [1, linenum, txt, imgPosition] (data of line pairs [the numbers of the first and the last lines, text of a line, and a coordinate of an object within an image]).

If an original file of contents is subtitles, the publisher's terminal (110) will generate a function of saveMOVT (BookName, movSize, publisher, timestamp, size, movTSize, lang, processed, script [1, movtNum, txt, movTPosition, duration]) before transmitting it to the database of original contents (121).

In this case, a function of saveMOVT includes the following parameters: BookName (name of the work); movSize (the length of a video); publisher (a copyright owner); timestamp (transmission time); size (size of a line file); movTSize (number of subtitle objects); lang (the kind of language); processed (the completion of a rough translation: initially 0, and 1 if completed); and script [1, movtNum, txt, movTPosition, duration] (data of subtitle pairs [the number of the first object, the number of an object, text of subtitles, point of playing a subtitle, duration of playing]).

The database of original contents (121) transmits original files of contents included with parameters to a translator for a rough translation (122) (S301). The original files of contents can include a function of saveTXT, or saveTOON, or saveMOVT as explained above.

The translator for a rough translation (122) transmits its data of rough translations to a database of rough translations (123) (S302).

If the data of rough translations are text only, the translator for a rough translation (122) generates a function of saveInitialTXT before transmitting it to the database of rough translations (123).

In this case, a function of saveInitialTXT includes the following parameters: uniqueID [BookName, EpisodeNum] (saving the rough translation of text (a unique number [name of the work, number of an episode]), txtFile [1, LineNum] (a text file (numbers from the first line to the last line)); fromLang (source language); toLang (target language); txtSize (the total number of lines); processed (the completion of revision: initially 0, and 1 if completed); and macProcessed (whether or not there is a record that shows a machine has performed a revision (0 if not, and 1 if there is)).

If the data of rough translations are lines (dialogues) of a webtoon, the translator for a rough translation (122) generates a function of saveInitialTOON before sending it to the database of rough translations (123).

In this case, a function of saveInitialTOON includes the following parameters: uniqueID [BookName, EpisodeNum] (saving the rough translation of text (a unique number [name of the work, number of an episode]), txtFile [1, LineNum, imgPosition] (data of an abstract (numbers of the first and the last lines, a coordinate of an image of each line)); fromLang (source language); toLang (target language); txtSize (the total number of lines); processed (the completion of revision: initially 0, and 1 if completed); and macProcessed (whether or not there is a record that shows a machine has performed a revision (0 if not, and 1 if there is)).

If the data of rough translations are subtitles, the translator for a rough translation (122) generates a function of saveInitialMOVT before transmitting it to the database of rough translations (123).

In this case, a function of saveInitialMOVT includes the following parameters: uniqueID [BookName, EpisodeNum] (saving the rough translation of text (a unique number [name of the work, number of an episode]), txtFile [1, LineNum, movtPosition] (data of an abstract (numbers of the first and the last lines, the time position of each subtitle in a video)); fromLang (source language); toLang (target language); txtSize (the total number of lines); processed (the completion of revision: initially 0, and 1 if completed)); and macProcessed (whether or not there is a record that shows a machine has performed a revision (0 if not, and 1 if there is)).

The database of rough translations (123) transmits its data of rough translations to a workstation for revision (124) (S303).

If the data of rough translations are the rough translations of text only, the database of rough translations (123) generates a function of sendInitialTXT; a function of sendInitialTOON if the data are the lines (dialogues) of a webtoon; and a function of sendInitialMOVT if the data are subtitles, before sending them to the workstation for revision (124).

The parameters of sendInitialTXT, sendInitialTOON, and sendInitialMOVT respectively are the same as those of saveInitialTXT, saveInitialTOON, and saveInitialMOVT.

The above-mentioned function of “save” is a command that orders data to be saved in a specific unit, and the function of “send” is a command that orders data to be sent to a particular unit.

The workstation for revision (124) shows the original contents (sentences in the source language), which are imported from the database of original contents (121), and the data of rough translations on the front-end display side by side.

For this purpose, the workstation for revision (124) generates a function of requestTXT to make a request for work on text such as a novel, and transmits it to the database of original contents (121). In this case, the requestTXT is a function that asks for the original text and includes parameters of BookName (name of the work), EpisodeNum (number of an episode), and txtFile [lineNum] (text [line number]).

If the workstation for revision (124) imports one line at a time, it would be very inefficient. So for more efficiency, it will import a bunch of lines at a time by summoning the number of the first line and the number of a second specific line using a function of requestBunchTXT (BookName (name of the work), EpisodeNum (number of an episode), and txtFile [lineNum] (text [line number])).

The workstation for revision (124) creates a function of requestTOON to make a request for work on a webtoon and transmit it to the database of original contents (121). In this case, the requestTOON is a function that requests the original contents of a webtoon and includes the parameters of BookName (name of the work), EpisodeNum (number of an episode), and script [lineNum] (text [line number]).

If the workstation for revision (124) imports one line at a time, it would be very inefficient. So for more efficiency, it will import multiple lines at a time by summoning the number of the first line and the number of a second specific line using a function of requestBunchTOON (BookName (name of the work), EpisodeNum (number of an episode), and script [lineNum] (text [line number])).

The workstation for revision (124) generates a function of requestMOVT to makes a request for work on subtitles and then transmits it to the database of original contents (121). In this case, the requestMOVT is a function that demands subtitles and includes the parameters of BookName (name of the work), EpisodeNum (number of an episode), and script [lineNum] (text [line number]).

If the workstation for revision (124) imports one line at a time, it would be very inefficient. So for more efficiency, it will import a bunch of lines at a time by summoning the number of the first line and the number of a second specific line using a function of a requestBunchMOVT (BookName (name of the work), EpisodeNum (number of an episode), and script [lineNum] (text [line number])).

As shown in the FIG. 3, the workstation for revision (124) can easily display sentences in the source language and their rough translations in pairs on the front-end display using parameters of BookName, EpisodeNum, and lineNum.

The workstation for revision (124) transmits the data of revised translations, which it has received from the database of rough translations (123), to the temporary database of rough translations (125) (S304).

Since the data of revised translations have already been revised when they are saved in the temporary database of rough translations (125), their processed parameter becomes one (1) (one=true, 0=false).

The workstation for revision (124) transmits a function that temporarily saves the revised translations of text, which is a saveCheckTXT (uniqueID [BookName, EpisodeNum], txtFile [1, LineNum], fromLang, toLang, txtSize, 1, and macProcessed), and the data of revised translations to the temporary database of rough translations (125) and saves them there.

The workstation for revision (124) sends a function that temporarily saves the revised translations of the lines (dialogues) of a webtoon, which is a saveCheckTOON (uniqueID [BookName, EpisodeNum], txtFile [1, LineNum, imgPosition], fromLang, toLang, txtSize, 1, and macProcessed), and the results of revision to the temporary database of rough translations (125) and saves them there.

The workstation for revision (124) transmits a function that temporarily saves the revised translations of subtitles, which is a saveCheckMOVT (uniqueID [BookName, EpisodeNum], txtFile [1, LineNum, movePosition], fromLang, toLang, txtSize, 1, and macProcessed), and the results of revision to the temporary database of rough translations (125) and saves them there.

The temporary database of rough translations (125) can revise its own data of revised translations once again by working with a translation unit of reinforcement learning (130). By doing this, it can overwrite its own existing data and saves the newly revised data in it. At this time, because the existing data of revised translations overwritten have already been revised when they are saved in the temporary database of rough translations (125), a process parameter and a macProcessed parameter respectively become one (1) (1=true, 0=false).

When the temporary database of rough translations (125) permanently saves the data of revised translations which it has revised once again by working with the translation unit of reinforcement learning (130), it uses a function of saveCheckTXT (uniqueID [BookName, EpisodeNum], txtFile [1, LineNum], fromLang, toLang, txtSize, 1, 1) if the data is text only; a function of saveCheckTOON (uniqueID [BookName, EpisodeNum], txtFile [1, LineNum, imgPosition], fromLang, toLang, txtSize, 1, 1) if the data is lines (dialogues) of a webtoon; and a function of saveCheckMOVT (uniqueID [BookName, EpisodeNum], txtFile [1, LineNum, movePosition], fromLang, toLang, txtSize, 1, 1) if the data is subtitles.

However, if the macProcessed equals one (1), the temporary database of rough translations (125) will delete the existing data of revised translations and then import the revised translations that have been automatically revised once again from the translation unit of reinforcement learning (130) and save them.

The temporary database of rough translations (125) transmits those data of revised translations, which it has newly saved, to a terminal for revision and proofreading (127) (S305).

The terminal for revision and proofreading (127) displays the data of revised translations imported from the temporary database of rough translations (125) and the original contents brought from the database of original contents (121) on a display unit (not shown) side by side. And then it begins to revise and proofread those revised translations by comparing them with their original contents.

The terminal for revision and proofreading (127) transmits the final translations, which it has revised and proofread, to the database of the final translations (128) (S306).

The database of the final translations (128) sends the data of final translations to the interface of the administrator's page (129) (S307).

The database of the final translations (128) creates a function of sendFinalTXT (uniqueID [BookName, EpisodeNum] (a unique number [name of the work, number of an episode], txtFile [1, LineNum] (the final text of translations [numbers of the first and the last lines]), fromLang (source language); toLang (target language), and txtSize (the total number of lines)), whose purpose is to transmit the final text of translation, and sends it to the interface of the administrator's page (129).

The database of the final translations (128) creates a function of sendFinalTOON (uniqueID [BookName, EpisodeNum], txtFile [1, LineNum, imgPosition] (the final lines (dialogues) [numbers of the first and the last lines, the coordinates of images]), fromLang, toLang, txtSize), whose purpose is to transmit the final translation of a webtoon, and sends it to the interface of the administrator's page (129).

The database of the final translations (128) creates a function of sendFinalMOVT (uniqueID [BookName, EpisodeNum], txtFile [1, LineNum, movtPosition] (the final subtitles [numbers of the first and the last lines, the positions of subtitles]), fromLang, toLang, txtSize), whose purpose is to transmit the final translation of subtitles, and sends it to the interface of the administrator's page (129).

The interface of the administrator's page (129) can allow overseas distributors to upload their documents (text) via an API (111) connected to overseas distribution networks and can also sell them to other overseas distributors (S308).

The terminal for revision and proofreading (127) generates triple sentence pairs from the data of translations it has revised and proofread and then transmits them to the database of revised sentence pairs (129a) (S309).

The triple sentence pairs are composed of original sentences in the source language, sentences of a rough translation, and sentences of a revised translation, and are used as data for reinforcement learning.

For instance, in the case of a Korean to English translation, triple sentence pairs consist of sentences in Korean, sentences of a rough English translation, and sentences of a revised English translation (a data for revision and proofreading).

In the case of a Spanish to Chinese translation, triple sentence pairs are composed of sentences in Spanish, sentences of a rough Chinese translation, and sentences of a revised Chinese translation.

The three components of a triple sentence pair can be compared with each other for revision, such as between an original sentence and its revised translation, and between a sentence of a rough translation and its revised translation.

The terminal for revision and proofreading (127) generates a function of sendTSP (uniqueID (a unique number), origin (original sentences), initialTXT (roughly translated sentences), finalTXT (sentences of final translation), fromLang (source language), toLang (target language), and feed (whether or not sentences will be processed by AI (0, 1))), whose purpose is to transmit triple sentence pairs, and transmits it to the database of revised sentence pairs (129a).

The database of revised sentence pairs (129a) transmits its triple sentence pairs to the translation unit of reinforcement learning (130) (S310).

The database of revised sentence pairs (129a) creates a function of deepFeed (uniqueID (a unique number), origin (original sentences), initialTXT (roughly translated sentences), finalTXT (sentences of final translation), fromLang (source language), toLang (target language), and feed (whether or not sentences will be processed by AI (0, 1))), whose purpose is for triple sentence pairs to be processed, and sends it to the translation unit of reinforcement learning (130).

A translation algorithm of reinforcement learning learns the data imported by its own request for feed.

The database of revised sentence pairs (129a) transmits its new data simply to learn the translation algorithm of reinforcement learning (AI) through deep learning.

The translation algorithm of reinforcement learning can automatically revise the data (macprocessed=0) that haven't been revised in the temporary database of rough translations (125), depending on the command of activation or stop.

The command of activation or stop is macCheck (1 or 0). As for a request for revision of a specific data, a function of macCheck (uniqueID [BookName, EpisodeNum], txtFile [1, LineNum]) is used for text-only contents; and a function of macCheck (uniqueID [BookName, EpisodeNum], script [1, LineNum]) is used for both webtoons and subtitles.

The translation unit of reinforcement learning (130) automatically conducts a revision using the translation algorithm of reinforcement learning, before the workstation for revision (124) carries out a revision (that is, before it uploads data to the temporary database of rough translations (125)) (S311).

The workstation for revision (124) generates a breakdown of revisions and information on revision performance and transmits them to the database of revision performance (124a) (S312).

The workstation for revision (124) saves the performance data on revisions in the database of revision performance (124a) and helps the interface of the administrator's page (129) to efficiently manage the performance of revisions.

In addition, the workstation for revision (124), arbitrarily using the data from the database of revision performance (124a), determines the suitability on the basis of a correlation function by taking into account the efficiency of revision, compatibility with a genre, a t-test between automatic revision algorithms, ANOVA, and the like.

An automatic algorithm that gets the highest points of suitability will be put into the automatic revision that uses reinforcement learning.

The workstation for revision (124) saves performance of revisions in the database of revision performance (124a) whenever it finishes one session or one unit of objects.

One session is completed when it is automatically saved every 10 minutes, or when the connection of the workstation for revision is terminated or when one cycle is finished. The criteria for a session that saves revision performance can be set on the interface of the administrator's page (129).

Information on the revision performance is automatically saved when one unit of objects (one episode, one webtoon, or one video) is finished.

The workstation for revision (124) generates a function of savePerf, whose purpose is to save information on revision performance, and transmits it to the database of revision performance (124a).

In this case, the savePerf includes the following parameters: sessionID (a session's unique number), workerID (a worker's ID), BookName (name of the work), EpisodeName (number of an episode), lineNum (numbers from the first line to the last line), timestamp (work time), txtSize (the total number of words to work on), finalTxtCost (number of sentences that needed proofreading), errorDetected (number of errors detected), and genreFit (points of compatibility with a genre).

The embodiments of this invention shown above so far can not just be realized with a device and/or a method. But they also can be materialized by a program designed to realize facilities corresponding to the constituents of this invention's embodiments, or by a medium that is recorded with that program. In addition, any expert in this field of technology to which this invention belongs can easily materialize the above embodiments using the mechanisms explained above.

Though the embodiments of this invention were described in detail as above, the scope of the invention is not limited to the above description but extends to its multiple variations and improved versions that this inventor can make using the fundamental concepts of this invention.

### DESCRIPTION OF NUMERICAL CODES

100: a translation system; 110: a publisher's terminal; 111: an API linked to overseas distribution networks; 120: a translation-providing server; 121: a database of original contents; 122: a translator for a rough translation; 123: a database of rough translations; 124: a workstation for revision; 124a: a database of revision performance; 125: a temporary database of rough translations; 126: a control unit; 127: a terminal for revision and proofreading; 128: a database of the final translations; 129: an interface of the administrator's page; 129a: a database of revised sentence pairs; and 130: a translation unit of reinforcement learning.

What is claimed is:

1. A transformer translation system for deep learning using triple sentence pair, comprising:
a database of original contents, wherein the database of original contents receives original files of contents via a publisher's terminal;
a translator for a rough translation, wherein the translator produces data of rough translations by doing a machine translation of the original contents using a deep-learning algorithm of an artificial neural network;
a workstation for revision, wherein the workstation imports the original contents and the data of rough translations and displays the original contents and the data of rough translations side by side on a first monitor, and saves data of revised translations, wherein the workstation revises the data of revised translations by comparing the original contents with the rough translations; and
a terminal for revision and proofreading, wherein the terminal imports the original contents and the data of revised translations, displays the original contents and the data of revised translations side by side on a second monitor, and saves data of translations, wherein the terminal revises and proofreads the data of translations by comparing the original contents with the revised translations.

2. The transformer translation system for the deep learning using the triple sentence pair according to claim 1, further comprising:
a database of the final translations, wherein the database of the final translations saves the data of translations revised and proofread, wherein the data of translations revised and proofread are received from the terminal for revision and proofreading; and
an interface of an administrator's page, wherein the interface of the administrator's page provides a user interface, wherein the data of final translations revised and proofread is allowed to be accessed or downloaded through the user interface by connecting to the database of the final translations.

3. The transformer translation system for the deep learning using the triple sentence pair according to claim 1, further comprising a database of revised sentence pairs directly connected to the terminal for revision and proofreading, wherein the database of revised sentence pairs generates triple sentence pairs made up of sentences in a source language, roughly translated sentences, and sentences of the revised translations (data for the above revision and proofreading), the sentences of the revised translations will be configured for reinforcement learning, the database of revised sentence pairs receives the triple sentence pairs from the terminal for revision and proofreading and saves the triple sentence pairs.

4. The transformer translation system for the deep learning using the triple sentence pair according to claim 3, further comprising a translation unit of reinforcement learning, wherein the translation unit of reinforcement learning receives the triple sentence pairs from the database of revised sentence pairs and automatically revises the triple sentence pairs using a translation algorithm of reinforcement learning before the workstation for revision does.

5. The transformer translation system for the deep learning using the triple sentence pair according to claim 2, further comprising: a database of revision performance, wherein the database of revision performance receives information on the revision performance, wherein the information is a breakdown of revisions, from the workstation for revision and saves the information; and
a control unit, wherein the control unit allows users to search or access the information on the revision performance via the interface of the administrator's page

6. The transformer translation system for the deep learning using the triple sentence pair according to claim 4, wherein the translation unit of reinforcement learning determines whether to carry out a revision based on a language in the original contents and a language in the data of revision and proofreading; and the translation unit of reinforcement learning makes sure languages are matched before performing a revision of the translations using deep learning in the translation algorithm of reinforcement learning.

7. The transformer translation system for the deep learning using the triple sentence pair according to claim 4, wherein if the translation unit of reinforcement learning does not perform a revision based on a language in the original contents and a language in the data of revision and proofreading, the translation unit of reinforcement learning will determine whether to conduct a revision based on a language of a first rough translation done in the translator for the rough translation and a language configured in the revised translations; and the translation unit of reinforcement learning makes sure languages are matched before carrying out a revision of the translations using deep learning in the translation algorithm of reinforcement learning.

8. The transformer translation system for the deep learning using the triple sentence pair according to claim 1, further comprising a database of rough translations, wherein the database of rough translations receives the data of rough translations from the translator for the rough translation, saves the data of rough translations, and transmits the data of rough translations to the workstation for revision;
if the data of rough translations are text only, the translator for the rough translation generates a function of saveInitialTXT and transmits the function of saveInitialTXT to the database of rough translations;
the saveInitialTXT comprises the following parameters: uniqueID [BookName, EpisodeNum] (saving the roughly translated text (a unique number [name of the work, number of an episode]), texFile [1, LineNum] (a text file (numbers from the first line to the last line)), fromLang (source language), tolang (target language), txtSize (a total number of lines), processed (a completion of revision: initially 0, and 1 if completed); and macProcessed (whether or not there is a record that shows a machine has performed a revision (0 if not, and 1 if there is)).

9. The transformer translation system for the deep learning using the triple sentence pair according to claim 1, wherein the workstation for revision generates a function of requestTXT to make a request for work on the text, and transmits the function of requestTXT to the database of original contents; and the requestTXT is a function, wherein the function asks for the original text and comprises parameters of BookName (name of the work), EpisodeNum (number of an episode), and txtFile [lineNum] (text [line number]); and if the workstation for revision wants to import multiple lines of text at a time, the workstation is allowed to use a function of requestBunchTXT (BookName (name of the work), EpisodeNum (number of an episode), and txtFile [lineNum] (text [line number])) to import lines of a first number to a second specific number.

10. The transformer translation system for the deep learning using the triple sentence pair according to claim 8, further comprising a temporary database of rough translations, wherein the temporary database of rough translations saves the data of revised translations that have been revised after they were received from the database of rough translations; and the workstation for revision generates a function of saveCheckTXT, wherein a purpose of the function of saveCheckTXT is to temporarily save results of textual revision, and the function of saveCheckTXT comprises parameters of uniqueID [BookName, EpisodeNum], txtFile [1, LineNum], fromLang, toLang, txtSize, 1, and macProcessed, and transmits the function and the data of revised translations to the temporary database of rough translations.

11. The transformer translation system for the deep learning using the triple sentence pair according to claim 4, wherein the database of revised sentence pairs generates a function of deepFeed (uniqueID (a unique number), origin (original sentences), initialTXT (roughly translated sentences), finalTXT (sentences of final translation), fromLang (source language), toLang (target language), and feed (whether sentences will be processed by AI (0, 1))), a purpose of the function of deepFeed is for triple sentence pairs to be processed, and transmits the triple sentence pairs to the translation unit of reinforcement learning.

12. The transformer translation system for the deep learning using the triple sentence pair according to claim 2, wherein the database of the final translations generates a function of sendFinalTXT, a purpose of the function of sendFinalTXT is to transmit a final text of translation, and the function of sendFinalTXT comprises the following parameters: uniqueID [BookName, EpisodeNum] (a unique number [name of the work, number of an episode], txtFile [1, LineNum] (the final text of translation [numbers of the first and the last lines]), fromLang (source language); toLang (target language), and txtSize (the total number of lines)); and the database of the final translations transmits the function to the interface of the administrator's page.

13. The transformer translation system for the deep learning using the triple sentence pair according to claim 3, wherein the terminal for revision and proofreading creates a function of sendTSP, a purpose of the function of sendTSP is to transmit triple sentence pairs, and comprises the following parameters: uniqueID (a unique number), origin (original sentences), initialTXT (roughly translated sentences), finalTXT (sentences of final translation), fromLang (source language), toLang (target language), and feed (whether or not sentences will be processed by AI (0, 1)); and the terminal sends the function to the database of revised sentence pairs.
